(19) United States
(12) Patent Application Publication
(10) Pub. No.: US 2014/0272757 A1
(43) Pub. Date: Sep. 18, 2014

(54) ORTHODONTIC DEVICE AND METHOD

(71) Applicant: Zia CHISHTI, Washington, DC (US)

(72) Inventor: Zia CHISHTI, Washington, DC (US)

(21) Appl. No.: 14/214,322

(22) Filed: Mar. 14, 2014

Related U.S. Application Data
(60) Provisional application No. 61/800,961, filed on Mar. 15, 2013.

(51) Int. Cl. A61C 7/12; A61C 7/00; A61C 13/00

(52) U.S. Cl. CPC A61C 7/125; A61C 13/0019; A61C 7/002
USPC 433/18; 433/24; 264/16

(57) ABSTRACT

A device for moving at least one tooth includes at least one grip bonded to the at least one tooth and a strip including at least one receiving feature. The strip is configured to receive the at least one grip for attachment to the strip, and attachment of the strip to the at least one grips generates a tooth-moving force. A method of moving at least one tooth includes bonding at least one grip to the at least one tooth, providing a strip including at least one receiving feature, attaching the strip to the at least one grip for attachment to the strip, and generating a tooth-moving force.

### CROSS-REFERENCE TO RELATED PATENT APPLICATIONS

This application claims the benefit of U.S. Provisional Application No. 61/800,961, filed Mar. 15, 2013, the entire contents of which are incorporated herein by reference.

### BACKGROUND

The present application relates generally to the field of orthodontics. More specifically, the present application relates to an orthodontic device and method for moving teeth.

Tooth movement has conventionally been accomplished by various devices and methods including traditional wire and bracket devices (i.e., braces), lingual wire and bracket devices, and dental aligners including polymeric shells. With the advent of computers and digital modeling and manipulation, additionally devices and methods have been developed to use computers, scanners, and/or digital models of tooth positions to perform virtual treatment planning for fabricating wire and bracket devices and dental aligners including polymeric shells.

Although the aforementioned conventional devices and methods may have benefits, they also have significant disadvantages. For example, although traditional wire and bracket devices may provide a treating professional with a variety of treatment strategies, such devices are highly visible and interfere with the aesthetic appearance of teeth. A patient may therefore find such devices highly undesirable. Lingual wire and bracket devices, while not visible, nevertheless pose difficulties for the treating professional in adjusting archwires, as the angles needed to gain access to such archwires during treatment can present challenges.

In particular, lingual bracket and wire devices can cause irritation of the inner mouth tissues and tongue due to being generally uneven. Finally, dental aligners, although almost invisible when placed over a person's teeth, must typically be fabricated as negatives of a positive mold of a set of teeth at a specialized fabrication site, and then shipped to a patient or treatment professional. Such fabrication requirements result in greater implementation delays compared to wire and bracket devices.

A need exists for improved technology, including technology that provides aesthetically pleasing devices and efficient methods for moving teeth.

### SUMMARY

An exemplary embodiment relates to a device for moving at least one tooth. The device includes at least one grip bonded to the at least one tooth and a strip including at least one receiving feature. The strip may be configured to receive the at least one grip for attachment to the strip, and attachment of the strip to the at least one grips generates a tooth-moving force.

Another exemplary embodiment relates to a method of moving at least one tooth. The method includes bonding at least one grip to the at least one tooth, providing a strip including at least one receiving feature, attaching the strip to the at least one grip for attachment to the strip, and generating a tooth-moving force.

Yet another exemplary embodiment relates to a method of producing an orthodontic element for moving teeth. The method includes attaching at least one grip to a set of teeth of a patient, the set of teeth being in an initial configuration. The method further includes scanning the set of teeth, creating a three-dimensional computer model of the set of teeth with the at least one grip attached thereto, determining a subsequent configuration for the set of teeth, generating a three-dimensional computer model of the set of teeth in the subsequent configuration, and fabricating a strip with at least one receiving feature that corresponds to the subsequent configuration of the set of teeth.

Another exemplary embodiment relates to a grip configured to be bonded to at least one tooth. The grip includes at least one bond site and at least one engagement portion configured to mate with a receiving portion of a strip such that mating generates a tooth-moving force. The receiving portion includes at least one receiving feature shaped to receive the engagement portion.

### BRIEF DESCRIPTION OF THE DRAWINGS

The accompanying drawings, which are included to provide further understanding of the invention, are incorporated in and constitute a part of this specification, illustrate embodiments of the present disclosure and together with the detailed description serve to explain the principles of the present disclosure. No attempt is made to show structural details of the present disclosure in more detail than may be necessary for a fundamental understanding of the present disclosure and the various ways in which it may be practiced. The patent or application file contains at least one drawing executed in color. Copies of this patent or patent application publication with color drawing(s) will be provided by the Office upon request and payment of the necessary fee.

FIG. 1 is a flow diagram of a process for moving at least one tooth in accordance with an exemplary embodiment.

FIG. 2 is a flow diagram of a process for producing an orthodontic element for moving teeth in accordance with an exemplary embodiment.

FIG. 3a depicts a first cross-section of a female element for moving teeth in accordance with a first exemplary embodiment.

FIG. 3b depicts a second cross-section of a female element for moving teeth in accordance with the first exemplary embodiment.

FIG. 3c depicts a first cross-section of a male element for moving teeth in accordance with the first exemplary embodiment.

FIG. 3d depicts a second cross-section of a male element for moving teeth in accordance with the first exemplary embodiment.

FIG. 3e depicts a cross-section of a male element atop a female element in accordance with the first exemplary embodiment.

FIG. 3f depicts a component for moving teeth having two female elements, in accordance with the first exemplary embodiment.

FIG. 3g depicts a second cross-section of a male element atop a female element in accordance with the first exemplary embodiment.

FIG. 3h depicts a component for moving teeth having two male elements, in accordance with the first exemplary embodiment.

FIG. 3i depicts a third cross-section of a female element for moving teeth in accordance with a first exemplary embodiment.

FIG. 3j depicts a third cross-section of a male element for moving teeth in accordance with a first exemplary embodiment.

FIG. 3k depicts a third cross-section of a male element atop a female element in accordance with the first exemplary embodiment.

FIG. 4a depicts two male elements for moving teeth in accordance with a second exemplary embodiment.

FIG. 4b depicts four male elements for moving teeth in accordance with the second exemplary embodiment.

FIG. 4c depicts a cross-section of a female element for moving teeth in accordance with the second exemplary embodiment.

FIG. 5a depicts a cross-section of a female element for moving teeth in accordance with a third exemplary embodiment.

FIG. 5b depicts a male element for moving teeth in accordance with the third exemplary embodiment.

FIG. 5c depicts a cross-section of a second female element for moving teeth in accordance with the third exemplary embodiment.

FIG. 5d depicts a perspective view of a female element for moving teeth in accordance with the third exemplary embodiment.

FIG. 5e depicts a cross-section of a third female element for moving teeth in accordance with the third exemplary embodiment.

FIG. 5f depicts a cross-section of a fourth female element for moving teeth in accordance with the third exemplary embodiment.

FIG. 6a depicts a female element for moving teeth in accordance with a fourth exemplary embodiment.

FIG. 6b depicts a cross-section of the female element for moving teeth in accordance with the fourth exemplary embodiment.

FIG. 6c depicts a male element for moving teeth in accordance with the fourth exemplary embodiment.

FIG. 6d depicts a cross-section of the male element for moving teeth in accordance with the fourth exemplary embodiment.

FIG. 6e depicts a second male element for moving teeth in accordance with the fourth exemplary embodiment.

FIG. 7a depicts a female element for moving teeth in accordance with a fifth exemplary embodiment.

FIG. 7b depicts a plurality of elements for moving teeth in accordance with the fifth exemplary embodiment.

FIG. 7c depicts a linking element for moving teeth in accordance with the fifth exemplary embodiment.

FIG. 7d depicts a first linkage for moving teeth in accordance with the fifth exemplary embodiment.

FIG. 7e depicts a second linkage for moving teeth in accordance with the fifth exemplary embodiment.

FIG. 7f depicts a strip for moving teeth in accordance with the fifth exemplary embodiment.

FIG. 7g depicts a second female element for moving teeth in accordance with the fifth exemplary embodiment.

FIG. 8a depicts a first strip for moving teeth in accordance with a sixth exemplary embodiment.

FIG. 8b depicts an alternate view of the first strip for moving teeth in accordance with the sixth exemplary embodiment.

FIG. 8c depicts a second strip for moving teeth in accordance with the sixth exemplary embodiment.

FIG. 8d depicts an alternate view of the second strip for moving teeth in accordance with the sixth exemplary embodiment.

FIG. 9a depicts a female element for moving teeth in accordance with a seventh exemplary embodiment.

FIG. 9b depicts a cross-section of a male element for moving teeth in accordance with the seventh exemplary embodiment.

FIG. 9c depicts a male element for moving teeth in accordance with the seventh exemplary embodiment.

FIG. 9d depicts two female elements for moving teeth in accordance with the seventh exemplary embodiment.

FIG. 9e depicts the two female elements for moving teeth in accordance with the seventh exemplary embodiment.

FIG. 9f depicts a cross-section of the two female elements for moving teeth in accordance with the seventh exemplary embodiment.

FIG. 9g depicts the two female elements for moving teeth in accordance with the seventh exemplary embodiment.

FIG. 9h depicts a cross-section of a male element for moving teeth in accordance with the seventh exemplary embodiment.

FIG. 9i depicts a second male element for moving teeth in accordance with the seventh exemplary embodiment.

FIG. 9j depicts a second cross-section of a male element for moving teeth in accordance with the seventh exemplary embodiment.

FIG. 9k depicts a third male element for moving teeth in accordance with the seventh exemplary embodiment.

FIG. 10a depicts a perspective view of a first strip and a first set of male elements for moving teeth in accordance with an eighth exemplary embodiment.

FIG. 10b depicts a protrusion that is part of a first male element of the first set of male elements for moving teeth in accordance with the eighth exemplary embodiment.

FIG. 10c depicts a front view of the first strip and the first set of male elements for moving teeth in accordance with the eighth exemplary embodiment.

FIG. 10d depicts an assembly of the first strip and the first set of male elements for moving teeth in accordance with the eighth exemplary embodiment.

FIG. 10e depicts an alternate view of the first strip for moving teeth in accordance with the eighth exemplary embodiment.

FIG. 11a depicts an assembly of a first strip for moving teeth and a first set of male elements in accordance with a ninth exemplary embodiment.

FIG. 11b depicts a protrusion that is part of a first male element of the first set of male elements in accordance with the ninth exemplary embodiment.

FIG. 11c depicts the first strip for moving teeth in accordance with the ninth exemplary embodiment.

FIG. 11d depicts the protrusion that is part of the first male element as disposed on a backing, in accordance with the ninth exemplary embodiment.

### DETAILED DESCRIPTION OF EMBODIMENTS

Before turning to the figures, which illustrate the exemplary embodiments in detail, it should be understood that the present disclosure is not limited to the details or methodology set forth in the description or illustrated in the figures. It should also be understood that the terminology is for the purpose of description only and should not be regarded as limiting. An effort has been made to use the same or like reference numbers throughout the drawings to refer to the same or like parts.

Embodiments of the present invention relate to devices and methods for moving teeth wherein orthodontic treatment elements may be invisible or nearly invisible and so as to minimize mouth-tissue irritation. Such devices and methods may use the precision and scalability of computer-enhanced techniques to generate precise and strategic treatment options. In some embodiments, such devices and methods are capable of being practiced in whole or in part at an office of a treating professional. By using cost-effective three-dimensional printing methods, the treating professional may generate custom orthodontic treatment elements that may be delivered to a patient on-site, thereby saving shipping costs, decreasing treatment delay inherent in dental aligner therapy, and providing significant real-time treatment control within the treating professional's office. Further, unlike dental aligner shells, some embodiments are capable of providing more substantial forces to at least one feature of the patient's teeth and/or jaw. Such increased forces may accomplish treatment objectives, such as, for example, creating a wider arch.

Some embodiments include at least one grip bonded to at least one tooth, and a strip having at least one receiving feature shaped to receive the at least one grip. In such embodiments, attachment of the strip to the at least one grip generates a tooth-moving force. In some embodiments, a tooth-moving force may be created by configuring the at least one receiving feature in the strip in a predetermined arrangement.

In particular, the tooth-moving force may be created by configuring at least receiving feature in the strips to be slightly misaligned from the at least one grip attached to a tooth. In some embodiments, such misalignment may be an approximate misalignment corresponding to a deviation in positioning. Attachment of the strip to the at least one grip generates a force to move the at least one tooth from an initial position to a subsequent position. As the at least one tooth moves in response to the force, alignment of the grips to the at least one receiving feature in the strips improves until no effective tooth-moving force is applied. Examples of such receiving features will be provided below. A cessation of an application of the tooth-moving force corresponds to the at least one tooth's movement from the initial position to the subsequent position. In other words, in at least one embodiment, the tooth-moving force is no longer applied when the at least one tooth is moved to the subsequent position. The strip may then be removed and a new strip attached with at least one further misalignment of at least one receiving feature corresponding to the at least one grip, thereby creating additional tooth movements as desired to translate a tooth position. Such additional tooth movements may be desired, for example, in order to achieve a distinct aesthetic effect.

FIG. 1 is a flow diagram of embodiments of a process 100 for moving at least one tooth in accordance with an exemplary embodiment. The method includes bonding at least one grip to the at least one tooth (110), providing a strip including at least one receiving feature (120), attaching the strip to the at least one grip for attachment to the strip (130), and generating a tooth-moving force by misaligning the at least one receiving feature (140). A performer of process 100 then determines (150) if the process 100 will be stopped (160) or repeated (beginning at 110) to move teeth subsequent to movement of the at least one tooth. The performer of process 100 can be, for example, a treatment professional, or it can be automated.

Unlike dental aligner shells, the strips of some embodiments are susceptible to being fabricated using cost-effective three-dimensional printing methods. The strips may be so fabricated because they have a thickness that may be at least as thick as a minimum feature size of a cost-effective three-dimensional printer. Fabrication of the at least one receiving feature within the strip is configured to provide the tooth-moving force. As long as the minimum feature size is maintained, cost-effective three-dimensional printers may create high-resolution receiving features required to apply precise tooth-moving forces.

At least one embodiment relates to methods that, when integrated with contemporary tooth-scanning and computer modeling methods, permit an appliance or device for translational motion of teeth. Such appliances or devices may be designed, manufactured, and delivered during a single office visit to the treating professional. The appliance or device is an orthodontic element configured for use over the course of the office visit. Upon arrival, the at least one grip may be configured to be attached to an upper and/or lower set of a patient's teeth. Each set may include one or more teeth. Such sets may then be scanned using a scanner, such as an intraoral scanner, to immediately create a three-dimensional computer model of the patient's teeth with the at least one grip attached thereto. In some embodiments, a non-transitory computer-readable storage medium may have instructions stored thereon that, when executed by a processor, cause the processor to perform operations comprising creation of the three-dimensional computer model.

From such an initial configuration of teeth, a new configuration of tooth placements may be determined computationally, using one or more computers, either with or without human operator involvement, to create a computer model using a computer to represent a subsequent arrangement of teeth. Then, using a three-dimensional printer that may be located at the treating professional's office, a strip with at least one receiving feature corresponding to the subsequent arrangement of teeth may be fabricated with the printer.

FIG. 2 is a flow diagram of a process 200 for producing an orthodontic element for moving teeth in accordance with an exemplary embodiment. The method includes bonding at least one grip to a set of teeth or at least one tooth of a patient such that the at least one grip is securely attached (210). In some embodiments, the method includes attaching the at least one grip to the set of teeth or the at least one tooth via processes other than bonding. Upon attachment, the set of teeth are in an initial configuration. Next, scanning the set of teeth is performed with a scanner (220). Scans produced during scanning using one or more computers are employed for creating a three-dimensional computer model of the set of teeth with the at least one grip attached to the set of teeth (230). After creating the three dimensional computer model, a subsequent configuration for the set of teeth may be determined (240). Then, a three-dimensional computer model may be generated using one or more computers to depict the set of teeth in the subsequent configuration (250). Following generation of the three-dimensional model depicting the teeth in the subsequent configuration, a strip may be fabricated with at least one receiving feature corresponding to the subsequent configuration of the set of teeth (260).

FIGS. 3a-11d, described below, relate to embodiments of a device for moving at least one tooth. Such embodiments may include at least one receiving feature that is configured to receive corresponding features. For example, in some embodiments, as shown in FIGS. 10a and 10c, a first component depicted above a second component may be provided with a plurality of openings in which to receive the second component. In some embodiments, at least one receiving feature may correspond to a female element. The at least one receiving element of some embodiments may be configured to receive a male element, as described below. In some embodiments, the at least one receiving feature may have characteristics of male and/or female elements, for example, as shown in FIG. 7a. Furthermore, in some embodiments, at least one receiving feature may correspond to at least one negative space feature.

FIG. 3a depicts a first cross-section of a female element for moving teeth in accordance with a first exemplary embodiment. In embodiments, the female element 100 may be positioned in various locations within a mouth and relative to the other components of a device for moving at least one tooth. The female element 100 is formed with indentations and comprises a receptacle configured to receive a corresponding male element. The female element 100 is formed in a strip 200. In some embodiments, at least one receiving feature is equivalent to the female element 100. Although female element 100 is shown in a rectilinear shape, it should be understood that the female element 100 can assume a variety of shapes each configured to mate with the shape of the corresponding male element, such as the male element 300 shown in FIG. 3k (described below). Further, it should be understood that the strip 100 can have any combination of male and/or female elements.

The shape of the male and female connections is such that the male and female elements can mate with each other. Although the male and female elements are configured to mate, they are shaped such that there is a misalignment between the male and female elements when mated. Due to such a misalignment, a tooth-moving force is generated on at least one tooth in at least one direction. In some embodiments, the misalignment may give rise to a tooth-moving force that may be exerted on at least one tooth in a plurality of directions. In particular, the misalignment may be slight but is nonetheless sufficient to cause the male and female elements to push against each other.

In some embodiments, the misalignment is deliberately provided and is not due to machine tolerances or an otherwise unintentional dimensioning and configuring of the respective male and/or female elements. In some embodiments, any combination of male and/or female elements may be arranged so as to generate a force, which is imparted to at least one tooth. In some embodiments, the resulting force may cause the at least one tooth to move with one degree of freedom. In some embodiments, the resulting force may cause the tooth to move with more than one degree of freedom, for example, up to six degrees of freedom.

Furthermore, in some embodiments, at least one receiving feature and/or at least one corresponding feature configured to be received by the at least one receiving feature are shaped in accordance with various design considerations. For example, in some embodiments, a male element and female element may be shaped to permit engagement in at least one direction, or by further way of example, in three directions. In some embodiments, the shape is chosen based on the direction in which force is sought to be applied. In some embodiments, the shape of the male and female element imposes constraints on the angle at which the male and/or female elements may be inserted. That is, elements with certain shapes may be more readily inserted into a patient's mouth. Furthermore, particular shapes and/or combinations of shapes may impose various degrees of difficulty with respect to the amount of effort required to insert and/or remove the respective male and/or female elements, whether they are inserted and/or removed individually or as part of a set of features.

It should be noted that the strip 200 need not be directly attached to any of the teeth itself, or even to the female element 100. In some embodiments, adhesive is used to connect the strip 200 to at least one tooth and/or to the first element 100. In some embodiments, adhesive is used to secure the female element 100 to at least one tooth. Further, in some embodiments, the force imparted by mating the male and female elements is sufficient to move at least one tooth but still permits the strip 200 to be movable rather than locked in place.

In some embodiments, a male element (not shown in FIG. 3a) is configured to mate with the female 100 element, which mating is configured to produce a translation force so as to move at least one tooth, as mentioned above. Thereafter, the male element is removed, i.e., un-mated with or disengaged from the female element 100. The disengagement of the male element and the female element 100 from each other permits freer movement of the strip 200. In some embodiments, the strip 200 may be configured with either male or female elements, and may be adhered to the back of at least one tooth or configured to engage with a corresponding strip attached to the back of the at least one tooth.

FIG. 3b-3k relate to the first exemplary embodiment. FIG. 3b depicts a second cross-section of a female element for moving teeth. FIG. 3c depicts a first cross-section of a male element for moving teeth. FIG. 3d depicts a second cross-section of a male element. FIG. 3e depicts a cross-section of a male element atop a female element, although in some embodiments, a female element may be disposed atop a male element. FIG. 3f depicts a component for moving teeth having two female elements. FIG. 3g depicts a second cross-section of a male element atop a female element. FIG. 3h depicts a component for moving teeth having two male elements. FIG. 3i depicts a third cross-section of a female element. FIG. 3j depicts a third cross-section of a male element for moving teeth. FIG. 3k depicts a third cross-section of a male element 300 atop the female element 100. A misalignment may occur, for example, at the location indicated by reference numeral 686. The misalignment results from the shape of female element 100 and the male element 300.

Turning now to a second exemplary embodiment as shown in FIGS. 4a-4c, FIG. 4a depicts two male elements for moving teeth. FIG. 4b depicts four male elements for moving teeth. The elements in FIGS. 4b-4c are configured to be receiving in corresponding receiving elements, such as the female element 100 described above, for example. FIG. 4c depicts a cross-section of a female element for moving teeth. In FIGS. 4a-4b, for example, each of the male elements has a triangular shape and projects from a backing or anchor portion.

The male elements shown in FIG. 4a are shown as two symmetrical complementary triangles; however, the male elements in some embodiments may be formed with other shapes and/or configurations, including circular and/or rectilinear and/or asymmetric shapes. Likewise, the female elements may also vary with respect to shape, as well as in the depth and configuration of their respective receptacles. In some embodiments, the backing or anchor is connected to at least one tooth using an adhesive. As mentioned above, in some embodiments, the strip 100 may have both female and male elements. A corresponding component received by the strip may likewise have any combination of all male, all female, or male and female elements, and/or features including aspects of both male and female elements.

In the embodiments shown in FIGS. 3a-4c, the male elements can be aligned in a direct manner with the female elements. More particularly, a face of a female element is positioned so as to align with a corresponding face of a male element. That is, if the male elements were disposed on a flat surface such as a table, the female elements could be mated with the male elements by directly positioning the female elements above the male elements without complicated angles and/or configurations. However, in some configurations, and for some patients, an alignment of the mating elements in this manner may be extremely difficult or impossible. In particular, in some circumstances, different insertion angles may be required, such as when pluralities of teeth are considerably misaligned.

In circumstances where patients' teeth are substantially misaligned, certain embodiments allow for ready insertion of the strip by providing the strip with an alternative configuration than the straight strip as shown in FIG. 3a. Such alternative configurations are described with reference to FIGS. 5a-5f below.

Referring to a third exemplary embodiment, FIGS. 5a-5f are described as follows. In contrast to the first and second exemplary embodiments, FIGS. 5a-5f relate to embodiments employing a dovetailed configuration for the strip and mating elements. The dovetailed configuration can be particularly advantageous in certain circumstances, particularly in comparison to a stiff or highly rigid strip that may be incompatible with misaligned teeth. Stiff or highly rigid strips would suffer from insertion problems because they cannot accommodate the curved and inconsistent shapes engendered by misalignment of the teeth.

FIG. 5a depicts a cross-section of a female element for moving teeth. FIG. 5b depicts a male element for moving teeth. FIG. 5c depicts a cross-section of a second female element for moving teeth. FIG. 5d depicts a perspective view of a female element for moving teeth. FIG. 5e depicts a cross-section of a third female element. FIG. 5f depicts a cross-section of a fourth female element.

For embodiments featuring such dovetailed configurations, a different attachment procedure may be employed than the procedure used for the embodiments of FIGS. 3a-4c. For the embodiments shown in FIGS. 5a-5f, a face of a female element is arranged in a dovetailed manner over a face of a corresponding male element. The receptacles of the female elements shown in FIGS. 5a-5f may become wider and wider along the length of a strip. In some embodiments, the receptacles are slots of equivalent width. In some embodiments, some receptacles have the same width and others have differing widths.

The attachment procedure for the embodiments of FIGS. 5a-5f entails mating the male and female elements together one over the other. In such embodiments, the male elements may slide into the female elements rather than snap into place. The dovetailed configuration of the embodiments shown in FIGS. 5a-5f allows for a specific geometric configuration to be achieved and to realize an appropriate force translation.

FIGS. 6a-6g relate to a fourth exemplary embodiment. FIG. 6a depicts a female element for moving teeth. FIG. 6b depicts a cross-section of the female element for moving teeth. FIG. 6c depicts a male element for moving teeth. FIG. 6d depicts a cross-section of the male element for moving teeth. FIG. 6e depicts a second male element for moving teeth. It should be understood that the female and male elements may be disposed on a strip, adhered to the back of at least one tooth, or arranged in other configurations. In some implementations, the male elements may be positioned on a strip or an anchor, while the female elements are adhered to the back of at least one tooth, or vice-versa.

FIGS. 7a-7g relate to a fifth exemplary embodiment. In particular, FIG. 7a depicts a receiving element for moving teeth. FIG. 7b depicts a plurality of elements connected together by linkages for moving teeth. FIG. 7c depicts a linking element for linking at least one female element and at least one male element so as to move at least one tooth. FIG. 7d depicts a first linkage with female elements (not shown) disposed thereon. FIG. 7e depicts a second linkage for moving teeth. FIG. 7f depicts a strip for moving teeth. FIG. 7g depicts a second female element for moving teeth. This fifth exemplary embodiment allows for mating of the male and female elements by sliding the male and female elements into place relative to each other. In some circumstances, such embodiments are disposed in a mouth by first gluing a strip to a set of teeth, which strip is configured with a first type of mating element, and then sliding a plurality of mating elements of a second type over the strip.

FIGS. 8a-8d relate to a sixth exemplary embodiment. FIG. 8a depicts a first strip for moving teeth, and FIG. 8b depicts an alternate view of the first strip. FIG. 8c depicts a second strip for moving teeth, and FIG. 8d depicts an alternate view of the second strip for moving teeth.

FIGS. 9a-9e relate to a device for moving teeth in accordance with a seventh exemplary embodiment. FIG. 9a depicts a female element for moving teeth, while FIG. 9b depicts a cross-section of a male element for moving teeth. FIG. 9c depicts another male element. Each of FIGS. 9d-9e depicts two female elements. FIG. 9f depicts a cross-section of two female elements. FIG. 9g also depicts the two female elements. FIG. 9h depicts a cross-section of a male element for moving teeth. FIG. 9i depicts a second male element. FIG. 9j depicts a second cross-section of a male element. FIG. 9k depicts a third male element.

FIGS. 10a-10e relate to an eighth exemplary embodiment. FIG. 10a depicts a perspective view of a first strip and a first set of male elements for moving teeth in accordance with the eighth exemplary embodiment. FIG. 10a includes two separate substantially rectilinear components. The first substantially rectilinear component, shown toward the foreground of FIG. 10a, is a male component, as indicated by the plurality of protrusions projecting therefrom. In contrast, the second substantially rectilinear component, shown toward the background of FIG. 10a, is a female component, which is a strip that may be glued to the back of a patient's teeth.

In the eighth exemplary embodiment, as shown in FIG. 10a, the first substantially rectilinear component is printed as a strip provided with at least one protrusion. That is, the strip and at least one protrusion are formed together. Production of the strip having the at least one protrusion thereon obviates the need to attach each separate protrusion to the strip by adhering one-by-one. Thus, providing the strip together with the at least one protrusion can realize significant advantages in ease of assembly and labor.

Referring again to FIG. 10a, a method of manufacturing such a device may include producing the first substantially rectilinear component with at least one protrusion projecting therefrom. The method may further include adhering the first substantially rectilinear component with the at least one protrusion to the back of a set of teeth. The method may still further include creating the second corresponding substantially rectilinear component, i.e., a strip that serves as a female element. Further, the method may additionally include sliding one of the substantially rectilinear components over another of the substantially rectilinear components so as to generate a moving force. Alternatively, the method may include first providing the second substantially rectilinear component without the at least one protrusion and gluing that component to the back of a set of teeth prior to providing the first substantially rectilinear component.

FIG. 10b depicts a protrusion that is part of a first male element of the first set of male elements for moving teeth shown in FIG. 10a. FIG. 10c depicts a front view of the components shown in FIG. 10a. FIG. 10d depicts an assembly of the first and second components. FIG. 10e depicts an alternate view of the first and second components. The assembled configuration may be shaped so as to correspond generally to the shape of a patient's mouth.

FIGS. 11a-11d relate to a ninth exemplary embodiment. Referring first to FIG. 11c, FIG. 11c depicts a first strip having a plurality of receiving features. FIG. 11a depicts an assembly of the first strip shown in FIG. 11c and a second strip having a first set of male elements. FIG. 11b depicts a protrusion that is part of a first male element of the first set of male elements. FIG. 11 d depicts the protrusion that is part of the first male element as disposed on a backing.

In some embodiments, the strips may be fabricated from polymeric materials such as acrylonitrile butadiene styrene (ABS), a common inert, three-dimensional printing medium. In some embodiments, the strips may be fabricated from other media that have desired elastic or stiffness properties. The grips may also be fabricated from polymeric materials or other media that are stiff or elastic. Preferably, at least one of the grips or a strip has sufficient elasticity so as to create a resilient tooth-moving force. This may be determined computationally. However, such a resilient tooth-moving force is not inherently required by all embodiments. Moreover, any combination of the aforementioned materials may be used, or each material may be used not in combination with any of the other materials.

Some embodiments include grips attached to the teeth, where the grips may include elastic or stiff materials that are polymeric or inorganic in nature. The grips may correspond in some embodiments to the male elements. In some embodiments, the grips may correspond to the elements configured to be received by the at least one receiving feature. The grips may be of different sizes and shapes to apply different amounts of forces in various directions according to various techniques in order to translate or create tooth-moving forces in at least one direction. For example, a grip generally shaped like a cube may be used to provide full three-dimensional control of translational tooth movement, as the misalignment of the receiving space of the corresponding strip may have at least five planes from which forces may be applied.

In some embodiments, the grips may be cylindrical, pyramidal, or even asymmetrically or organically shaped. The grips may be different sizes, ranging from extremely small in volume, length, depth, or width, to larger in size so as to create a greater total surface on which tooth-moving forces may be applied by the at least one receiving feature of a strip. The at least one grip may be attached to a lingual or buccal surface of a tooth or to an appliance or attachment attached to a tooth (e.g., a crown, screw, pin, or bracket). To minimize soft-tissue irritation, the surface of the grip exposed to the soft tissues may be beveled or otherwise smoothed. In some embodiments, the surface of the grip may be coated with material that minimizes soft-tissue irritation.

In some embodiments, the grip may be configured to be bonded to at least one tooth. The grip includes at least one bond site and at least one engagement portion configured to mate with a receiving portion of a strip such that mating generates a tooth-moving force. Attachment of the at least one tooth may occur at the bond site. The receiving portion includes at least one receiving feature shaped to receive the engagement portion.

Some embodiments include strips that may include elastic or stiff materials that may be polymeric or inorganic in nature. The strips need not be limited to any particular shape or size; for example, the strip may be generally rectangular in profile or it may have a zig-zagging or oval profile. In some embodiments, a key shaping component of the strip is an orientation of the at least one receiving feature of the strip. The strip may be attached to grips attached on a lingual and/or buccal tooth orientation, and more than one strip may be attached in relation to a lower or upper set of teeth. Further the strips themselves may have positive features, such as hooks or other engagements for attaching the strip to other strips or other appliances, such as those on the opposing arch of teeth, or for springs, wires, or rubber bands. The strip may further have various negative or positive space features such that they may be used in combination with other tooth-moving devices, such as a wire and bracket device. Preferably, the strip is beveled or otherwise smoothed in order to minimize soft-tissue irritation. In some embodiments, the strip is coated with some material to minimize soft tissue irritation. To the extent that effective tooth-moving force and integrity may be maintained, a volume of the strip may be minimized so as to reduce interference with an original contour of the teeth exposed to soft tissue.

In some embodiments, the at least one receiving feature may possess various forms. For example, the at least one receiving feature may be a hole passing through a first surface of the strip to a second surface of the strip that opposes the first surface. The at least one receiving feature can, in some embodiments, be a cavity formed in the first surface of the strip that is covered by the opposing surface of the strip. The at least one receiving feature may progress horizontally or vertically within the strip, or progress in some combination of horizontal or vertical angles.

To overcome challenges vis-á-vis an angle of insertion required for attaching a strip, it may be preferable in some embodiments to dispose the at least one receiving feature of the strip to progress from a bottom of the strip (i.e., the portion of the strip generally facing the root of the teeth) but not through to a top of the strip. Disposing the at least one receiving feature in this manner may mitigate challenges associated with various angles of insertion. In some alternative embodiments, the receiving feature may progress from a surface of the strip that is closest to the tooth to a surface that is furthest, without progressing past the furthest surface. Some embodiments include insertion guides configured to be disposed on areas of the strip, where such guides provide additional receiving space. In such embodiments, upon insertion of the strip, the at least one receiving feature assists in directing the strip to engage the grips attached to the teeth.

In some embodiments, the at least one receiving feature of a strip typically corresponds to the shape of the grip that generally fits or engages with the at least one receiving feature. The walls of the strip defining the receiving feature are members by which tooth moving forces are generally created or translated to a grip. It may be desirable in some instances to have the walls of the receiving feature engage with all or most of surface planes of the grip. However, in some embodiments, it may be advantageous to limit engagement of these walls to certain surface planes of the grip to, for example, overcome challenges with the angle required to attach a strip to grips attached to two or more teeth.

In some embodiments, it may be preferable to include strips that are manufactured by computer-controlled manufacturing methods. However, in other embodiments, positive molds may be created for a patient's teeth with grips attached thereto, for example, using a cast of a negative impression of the teeth. From such molds, different tooth positions may be simulated and strips may be formed onto new arrangements of teeth. The strips are configured to then be removed and attached to actual grips on a patient's teeth.

Other configurations of the orthodontic devices, and other combinations of processes of the orthodontic methods are possible according to various other embodiments. Furthermore, it should be noted that the features of the devices and methods may be used in combination with any of the other features of the devices and methods disclosed herein.

As may be utilized herein, the terms “approximately,” “about,” “substantially,” “essentially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” as may be used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” “attached,” and the like as used herein mean the joining of two members or elements directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the Figures. It should be noted that the orientation of various elements may differ according to other exemplary embodiments, and that such variations are intended to be encompassed by the present disclosure.

In some embodiments, certain features may be shown as being hollow to better illustrate their physical characteristics. It will be understood that those features depicted as being hollow for the purposes of illustration may be solid.

It is important to note that the construction and arrangement of the orthodontic devices as shown in the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, manufacturing processes, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to exemplary embodiments. Other substitutions, modifications, changes and omissions may also be made in the design, operating conditions and arrangement of the various exemplary embodiments without departing from the scope of the present disclosure.

What is claimed is:

1. A device for moving at least one tooth, the device comprising:
at least one grip bonded to the at least one tooth,
a strip including at least one receiving feature, the strip being configured to receive the at least one grip for attachment thereto,
wherein attachment of the strip to the at least one grip generates a tooth-moving force in at least one direction.

2. The device of claim 1, wherein the at least one receiving feature is a negative space feature.

3. The device of claim 1, wherein the at least one receiving feature in the strip is misaligned from the at least one grip bonded to the at least one tooth.

4. The device of claim 3, wherein the tooth moving force includes a force produced by the at least one receiving feature that is misaligned from the at least one grip bonded to the at least one tooth.

5. The device of claim 1, wherein the strip comprises a three-dimensional printed medium.

6. The device of claim 1, wherein the attachment is configured to generate the tooth-moving force to move the at least one tooth from an initial position to a subsequent position.

7. The device of claim 3, wherein the tooth-moving force moves the at least one tooth from an initial position to a subsequent position.

8. The device of claim 6, wherein movement of the at least one tooth from the initial position to the subsequent position corresponds to improved alignment between the at least one grip and the at least one receiving feature such that the tooth-moving force ceases to be generated upon achievement of the subsequent position.

9. A method of moving at least one tooth, the method comprising:
bonding at least one grip to the at least one tooth,
providing a strip including at least one receiving feature,
attaching the strip to the at least one grip for attachment thereto, and
generating a tooth-moving force.

10. The method of claim 9, wherein the at least one receiving feature is a negative space feature.

11. The method of claim 9, wherein the generating a tooth moving force step comprises misaligning at least one receiving feature in the strip from the at least one grip bonded to the at least one tooth.

12. The method of claim 9, wherein the providing the strip step comprises forming the strip from a three-dimensional printing medium.

13. The method of claim 9, wherein the providing a strip step comprises producing the strip with a three-dimensional printer.

14. The method of claim 9, wherein the method further comprises translating the at least one tooth from an initial position to a subsequent position.

15. A method of producing an orthodontic element for moving teeth, the method comprising:
attaching at least one grip to a set of teeth of a patient, the set of teeth being in an initial configuration;
scanning the set of teeth with a scanner;
creating, using one or more computers, a three-dimensional computer model of the set of teeth with the at least one grip attached thereto;
determining a subsequent configuration for the set of teeth;
generating, using the one or more computers, a three-dimensional computer model of the set of teeth in the subsequent configuration, and
fabricating a strip with at least one receiving feature corresponding to the subsequent configuration of the set of teeth.

16. The method of claim 15, wherein the fabricating the strip step comprises fabricating the strip in a three-dimensional printer located in an office of a treating professional during a patient visit to the office.

17. A grip configured to be bonded to at least one tooth, the grip comprising:
at least one bond site;
at least one engagement portion; the engagement portion being configured to mate with a receiving portion of a strip such that mating generates a tooth-moving force,
wherein the receiving portion comprises at least one receiving feature shaped to receive the engagement portion.

18. The grip of claim 17, wherein the at least one receiving feature is a negative space feature.

19. The grip of claim 17, wherein the grip is cubic.

20. The grip of claim 17, wherein the strip comprises a three-dimensional printed medium.
